(19) United States
(12) Patent Application Publication
(10) Pub. No.: US 2005/0136903 A1
(43) Pub. Date: Jun. 23, 2005

(54) Context dependent alert in a portable electronic device

(75) Inventors: Tsuyoshi Kashima, Yokohama (JP); Yoshiya Hirase, Tokyo (JP)

Correspondence Address: HARRINGTON & SMITH, LLP, 4 RESEARCH DRIVE, SHELTON, CT, 06484-6212, US

(73) Assignee: Nokia Corporation

(21) Appl. No.: 10/739,855

(22) Filed: Dec. 18, 2003

(51) Int. Cl. H04M 3/00

(52) U.S. Cl. 455/418

(57) ABSTRACT

A portable electronic device comprising: a user interface for providing an alert to a user; a memory for storing at least one value for each of a plurality of different context parameters; detection means for detecting a value for each of the plurality of different context parameters; and control means for determining when a detected value satisfies a rule involving a stored value for the same context parameter and for controlling the user interface to provide an alert. A portable electronic device comprising: a user interface for providing an alert to a user; detection means for detecting a context; a memory for storing a plurality of different trigger contexts; and control means for controlling the user interface to produce an alert when a detected context corresponds to a stored trigger context, wherein a context is defined by value(s) of one or more of a plurality of different context parameters.

### FIELD OF THE INVENTION

Embodiments of the present invention relate to the production of a context dependent alert in a portable electronic device.

### BACKGROUND TO THE INVENTION

Portable electronic devices such as, for example, mobile cellular telephones and personal digital assistants (PDA) typically have some form of Scheduler application. Such an application may be programmed by a user to provide an alert at a predetermined date and time. The alert may be an audible alert and/or the display of text or an icon in a display.

Such Scheduler applications are very similar to those developed for desk-top computers. The context for a desktop computer does not change frequently except for the passage of time. However, the context of a portable electronic device may continually change as the device is moved.

The inventors have realised that it would be desirable to provide a context-dependent alert in a portable electronic device.

### BRIEF DESCRIPTION OF THE INVENTION

According to one embodiment of the present invention there is provided a system comprising: a user interface for providing an alert to a user; detection means for detecting a context of the system; and control means for controlling the user interface to provide a context-dependent alert.

According to another embodiment of the present invention there is provided a computer program embodied in a memory device comprising: means for determining whether a current context corresponds to a pre-defined context; and means for controlling a user interface to provide an alert when a current context corresponds to a pre-defined context.

According to another embodiment of the present invention there is provided a portable electronic device comprising: a user interface for providing an alert to a user; a memory for storing at least one value for each of a plurality of different context parameters; detection means for detecting a value for each of the plurality of different context parameters; and control means for determining when a detected value satisfies a rule involving a stored value for the same context parameter and for controlling the user interface to provide an alert.

According to another embodiment of the present invention there is provided a method of providing a context dependent alert in a portable electronic device comprising: storing at least one value for each of a plurality of different context parameters; detecting the values of the plurality of different context parameters; determining when a detected context parameter satisfies a rule involving a stored value for that context parameter; and controlling a user interface to produce an alert.

According to another embodiment of the present invention there is provided a portable electronic device comprising: a user interface for providing an alert to a user; detection means for detecting a context; a memory for storing a plurality of different trigger contexts; and control means for controlling the user interface to produce an alert when a detected context corresponds to a stored trigger context, wherein a context is defined by value(s) of one or more of a plurality of different context parameters.

According to another embodiment of the present invention there is provided a method of providing a context dependent alert in a portable electronic device comprising: defining a plurality of different trigger contexts by storing, for each context, the value(s) of one or more of a plurality of different context parameters;
detecting a context by detecting the values of the plurality of different context parameters; and controlling a user interface to produce an alert when a detected context corresponds to a stored trigger context.

### BRIEF DESCRIPTION OF THE DRAWINGS

For a better understanding of the present invention and to understand how the same may be brought into effect, reference will now be made by way of example only to the accompanying drawings in which:

FIG. 1 is a schematic illustration of a portable electronic device according to one embodiment of the present invention; and

FIG. 2 schematically illustrates the process performed by a portable electronic device.

### DETAILED DESCRIPTION OF AN EMBODIMENT OF THE INVENTION

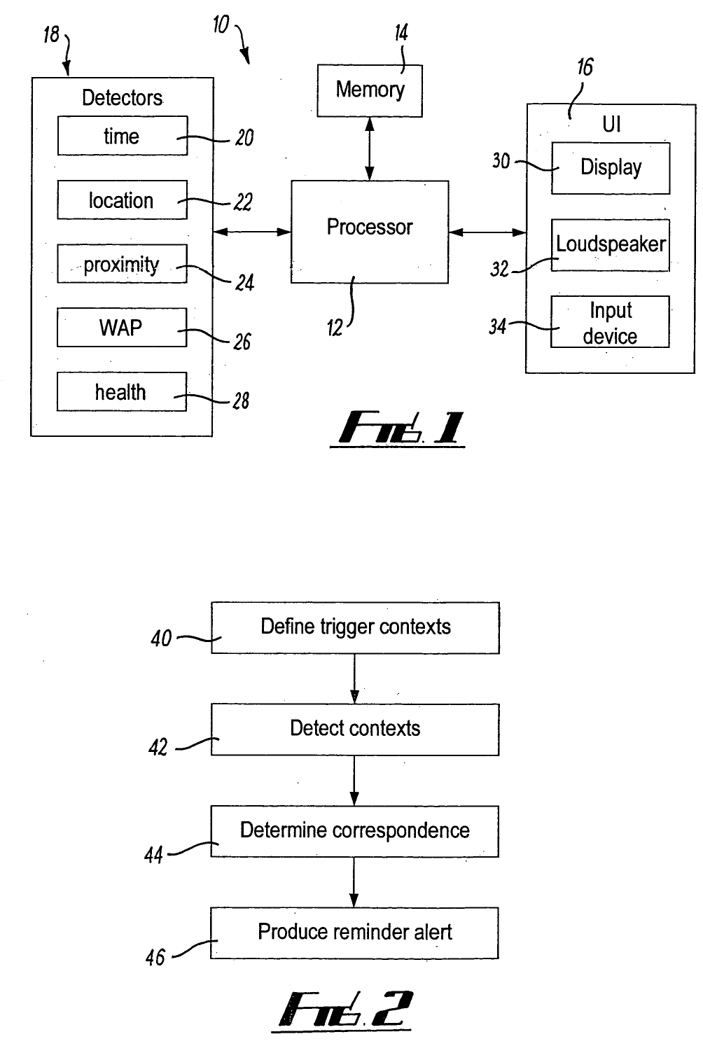

FIG. 1 generally illustrates a portable electronic device 10 comprising: a user interface 16 for providing an alert to a user; a memory 14 for storing at least one value for each of a plurality of different context parameters; detection means 18 for detecting a value for each of the plurality of different context parameters; and control means 12 for determining when a detected value satisfies a rule involving a stored value for the same context parameter and for controlling the user interface 16 to provide an alert.

FIG. 1 also generally illustrates a portable electronic device 10 comprising a user interface 16 for providing an alert to a user; detection means 18 for detecting a context; a memory 14 for storing a plurality of different trigger contexts; and control means 12 for controlling the user interface to produce an alert when a detected context corresponds to a stored trigger context, wherein a context is defined by the value(s) of one or more of a plurality of different context parameters.

In more detail, FIG. 1 illustrates a personal portable electronic device 10. The portable electronic device 10 comprises a processor 12; a memory 14; user interface 16 and a plurality of detectors 18. The processor 12 is connected to each of the memory 14, the user interface 16 and the detectors 18. The portable electronic device 10 is personal in that is generally carried on or about the person. The personal portable electronic device may or may not be capable of being shared between users but even if it is capable of being shared it is typically used by a single person.

The user interface 16 comprises a display 30, an audio output device 34 such as, for example, a loudspeaker, and a user input device 34 such as, for example, a keypad 34.

The processor 12 is operable to read from and write to the memory 14. The processor 12 is additionally operable to provide visual output via the display 30 and audio output via the loudspeaker 32. The processor 12 receives user input via the user input device 34.

The plurality of detectors 18, in this example, comprises a time detector 20, a location detector 22, a proximity detector 24, a communication interface 26 and a health detector 28. It should be appreciated that these detectors are merely examples and any one or more of these detectors may be present with or without the addition of further detectors that are not described in this example. Each detector provides a different context parameter to the processor 12.

The time detector 20 provides a real time value as its context parameter. The time detector 20 may, for example, be provided by a local clock or by a cellular radio transceiver that is capable of receiving a time indication from a cellular radiotelephone network. The local clock or cellular radio transceiver may be used for other purposes than time detection.

The location detector 22 provides a value indicating the location of the portable electronic device 10 as its context parameter. The location detector 22 may, for example, be provided by a global positioning system (GPS) chip-set or by a cellular radio transceiver that is capable of receiving a location identifier from a local base transceiver station of a cellular telephone network. The cellular radio transceiver may be used for other purposes than time detection.

The proximity detector 24 provides a value identifying a nearby portable electronic device. The proximity detector 24 is capable of detecting and identifying a nearby portable electronic device. The proximity detector may, for example, be provided by a RFID transponder that is capable of identifying a nearby portable electronic device that has an RFID tag by interrogating that RFID tag. Alternatively, the proximity detector may be a low power radio transceiver, such as a Bluetooth® transceiver, that is capable of communicating with a corresponding low power radio transceiver in another portable electronic device. The RFID transponder or Bluetooth transceiver may be used for other purposes than proximity detection.

The communicator 26 may, for example, be provided by a cellular radio transceiver that is capable of transmitting and receiving data. For example, the cellular radio transceiver may be operable to communicate using Wireless Application Protocol (WAP), I-mode or similar. The communicator 26 is capable of providing location information determined by the location detector 22 to a remote server and then receiving in reply location dependent information. The location dependent information may take many forms. It may relate, for example, to an expected weather forecast for that location etc.

The cellular radio transceiver may be used for other purposes than the communicator 26.

The health detector 28 detects one or more metrics that help determine the health of a user, such as the user's temperature, pulse rate and/or blood pressure.

The process performed by the portable electronic device 10 is illustrated schematically in FIG. 2. This process is controlled by the processor 12. The processor 12 is typically the CPU of the portable electronic device. Computer program instructions that are stored in memory 14 provide the described functionality when loaded into the processor 12.

At step 40, one or more trigger contexts are defined for the portable electronic device 10. Then, at step 42 the current context portable electronic device 10 is detected. Then at step 44 it is determined whether or not there is a correspondence between the detected current context and any one of the defined trigger contexts. If there is a correspondence a reminder alert is produced at step 46.

At step 40, the user is able to define a plurality of different trigger contexts using the user input device 34. These trigger contexts are then stored in the memory 14.

Each trigger context comprises a value for at least one context parameter as part of a reminder rule. A defined trigger context may relate to a single context parameter in a reminder rule or to multiple context parameters combined as a reminder rule. A reminder rule may be specified by using the value of a context parameter or the values of multiple context parameters and sequential logic.

For example, one reminder rule may specify that an alert is produced at a certain Location L e.g. the reminder rule could be “if (location=L) activate alert”, where ‘location’ is the context parameter value from the location detector 22.

For example, one reminder rule may specify that an alert is produced at a certain time T or at a certain location L e.g. the reminder rule could be “if ((time=T) OR (location=L)) activate alert”, where ‘time’ is the context parameter value from the time detector 20 and ‘location’ is the context parameter value from the location detector 22.

Another reminder rule may, for example, specify that an alert is produced if the electronic device is at a certain location L at a certain time T or is near a certain device D e.g. the reminder rule could be “if (((location=L) AND (time=T)) OR (proximity =D)) activate alert”, where ‘time’ is the context parameter value from the time detector 20, ‘location’ is the context parameter value from the location detector 22 and ‘proximity’ is the context parameter value from the proximity detector 24.

A reminder rule may or may not have a time element, but if it does have a time element it will have additional non-time elements and also logical operators.

The trigger context also allows the user to specify the nature of the reminder alert. It may, for example, be an audio alert by itself, or it may be a text alert by itself or it may be both a text and audio alert. A text alert involves the display of text on the display 30. The content of this text may be determined by the user and stored as part of a trigger context.

At step 42, the detectors 18 provide their context parameter values to the processor 12. The processor 12 compares the contemporaneous detected current values, which represent contemporaneous context parameter values against the trigger contexts stored in the memory 14. If the current contemporaneous context parameter values satisfy a reminder rule specified by one of the trigger contexts, then, at step 46, an alert is produced. This alert may be predetermined by the content of the corresponding trigger context.

Consequently, embodiments of the invention enable a user to use the portable electronic device to provide context dependent reminders. A context dependent reminder is a reminder that is not merely only time dependent, but is dependent on some other or some additional element such as location, the identity of a proximal device etc.

Embodiments of the present invention may be included within a Scheduler application that allows reminders to be produced according to a persons context and not just at a certain time.

The Scheduler application may, for example, be used to produce a reminder message on the display 30 as an alert when the user of the portable electronic device 10 is near a particular location. For example an alert may read “Need to go to the bank” and the user may specify that this reminder is produced, for example, when he passes near the bank or during a lunch hour. As another example, the user may use the Scheduler application to produce a “to-do list” as an alert on the display 30 when the user returns home or when the user returns to the office.

The electronic portable device 10 may be used to produce a reminder message as an alert when the user is next face to face with a friend or colleague. For example, the user may program the electronic portable device 10 to produce a reminder message such as “Need to give money back” to appear when the user is next near his friend John. This may, for example, be achieved by defining a reminder rule “if (proximity=John) display ‘Need to give money back’”, where proximity id the value of the context parameter provided by the proximity detector 24 and ‘John’ represents the Bluetooth ID of John's portable electronic device if the proximity detector is provided by a Bluetooth transceiver or represents the RFID value associated with John's portable electronic device if the proximity detector is an RFID transponder. Alternatively, other messages such as jokes or important facts may be recorded as the reminder message.

In another example, a standard reminder message may be programmed to be produced when the health of the user of the electronic portable device is in jeopardy. For example a reminder message to “Take medicine” may be produced if a user's blood pressure exceeds a certain threshold.

According to another scenario, the user may specify rules such that a reminder to take an umbrella is produced in the morning if there is a likelihood of rain that day in the user's home location or in the user's office location. The reminder may be combined with a time element so that it is produced in the morning to allow the user to bring an umbrella to work.

Although embodiments of the present invention have been described in the preceding paragraphs with reference to various examples, it should be appreciated that modifications to the examples given can be made without departing from the spirit and scope of the invention.

1. A system comprising:
a user interface for providing an alert to a user;
detection means for detecting a context of the system; and
control means for controlling the user interface to provide a context-dependent alert.

2. A system as claimed in claim 1, wherein the control means is arranged to control the user interface to provide an alert when a detected context corresponds to a stored context.

3. A system as claimed in claim 2, wherein the stored context is user programmable.

4. A system as claimed in claim 1, wherein the context dependent alert has a form of alert that is dependent upon the detected context.

5. A system as claimed in claim 1, wherein the alert comprises the communication of information.

6. A system as claimed in claim 5, further comprising a user interface comprising a display, wherein the context dependent alert comprises the presentation of text or image(s) on the display.

7. A system as claimed in claim 1, wherein the detection means is arranged to detect a location-dependent context and the control means is arranged to control the user interface to provide a location-dependent alert.

8. A system as claimed in claim 1, wherein the detection means is arranged to contemporaneously detect a plurality of different context parameters.

9. A system as claimed in claim 8, wherein the plurality of different context parameters comprises at least one user-dependent context parameter.

10. A system as claimed in claim 8, wherein the plurality of different context parameters comprises a parameter indicative of the location of the portable electronic device.

11. A system as claimed in claim 8, wherein one of the plurality of different context parameters identifies a proximal portable electronic device.

12. A computer program embodied in a memory device comprising:
means for determining whether a current context corresponds to a pre-defined context; and
means for controlling a user interface to provide an alert when a current context corresponds to a pre-defined context.

13. A computer program embodied in a memory device as claimed in claim 12, wherein the pre-defined context is location dependent.

14. A computer program embodied in a memory device as claimed in claim 12, wherein the pre-defined context is user-dependent.

15. A computer program embodied in a memory device as claimed in claim 12, wherein the re-defined context depends upon the proximity of an identified device.

16. A computer program embodied in a memory device as claimed in claim 12, wherein the pre-defined context depends upon location.

17. A computer program embodied in a memory device as claimed in claim 12, further comprising means for user programming of the pre-defined context.

18. A portable electronic device comprising:
a user interface for providing an alert to a user;
detection means for detecting a context; and
control means for controlling the user interface to provide a context-dependent alert.

19. A portable electronic device as claimed in claim 18, further comprising:
a memory for storing at least one value for each of a plurality of different context parameters, wherein the detection means is arranged to detect a value for each of the plurality of different context parameters; and the control means is arranged to determine when a detected value satisfies a rule involving a stored value for the same context parameter and for controlling the user interface to provide an alert.

20. A portable electronic device as claimed in claim 19, arranged to produce an alert when a detected value corresponds to a stored value for the same context parameter.

21. A portable electronic device as claimed in claim 20, wherein the alert is dependent upon the context parameter.

22. A portable electronic device as claimed in claim 19, arranged to produce an alert when a combination of detected context parameter values corresponds to a stored combination of values for the context parameters.

23. A portable electronic device as claimed in claim 22, wherein the alert is dependent upon the combination.

24. A portable electronic device as claimed in claim 19, wherein the memory is arranged to store a plurality of different trigger contexts each of which comprises a value for one of the different context parameters or comprises the values for plural context parameters and wherein the control means is arranged to control the user interface to produce an alert, when a detected context parameter or parameters corresponds to a stored trigger context.

25. A portable electronic device as claimed in claim 24, wherein the alert is dependent upon the trigger context.

26. A portable electronic device as claimed in claim 24, wherein a stored trigger context is user programmable.

27. A portable electronic device as claimed in claim 19, wherein the alert comprises the communication of information.

28. A portable electronic device as claimed in claim 27, wherein the user interface comprises a display and the alert comprises the presentation of text on the display.

29. A portable electronic device as claimed in claim 19, wherein the detection means is arranged to contemporaneously detect the plurality of different context parameters.

30. A portable electronic device as claimed in claim 19, wherein the plurality of different context parameters comprises at least one user-dependent context parameter.

31. A portable electronic device as claimed in claim 19, wherein one of the plurality of different context parameters identifies a proximal portable electronic device.

32. A portable electronic device as claimed in claim 31, wherein the plurality of different context parameters comprises a parameter indicative of the local time and also a parameter indicative of the location of the portable electronic device.

33. A method of providing a context dependent alert in a portable electronic device comprising:
detecting a context; and
controlling a user interface to provide a context-dependent alert.

34. A method of providing a context dependent alert in a portable electronic device comprising:
storing at least one value for each of a plurality of different context parameters;
detecting the values of the plurality of different context parameters;
determining when a detected context parameter satisfies a rule involving a stored value for that context parameter; and controlling a user interface to produce an alert.

35. A portable electronic device comprising: a user interface for providing an alert to a user; detection means for detecting a context; a memory for storing a plurality of different trigger contexts; and control means for controlling the user interface to produce an alert when a detected context corresponds to a stored trigger context, wherein a context is defined by value(s) of one or more of a plurality of different context parameters.

36. A portable electronic device as claimed in claim 35, wherein the user interface additionally provides for the user definition of a trigger context.

37. A portable electronic device as claimed in claim 35, wherein the user interface provides for the specification of the values of the context parameters to be included in the defined trigger context.

38. A portable electronic device as claimed in claim 35 wherein the user interface additionally provides for the specification of logic within the definition of a trigger context.

39. A portable electronic device as claimed in claim 35, wherein the alert is dependent upon the corresponding trigger context.

40. A portable electronic device as claimed in claim 35, wherein the alert comprises the communication of information.

41. A portable electronic device as claimed in claim 40, wherein the user interface comprises a display and the alert comprises the presentation of text on the display.

42. A portable electronic device as claimed in claim 35, wherein the detection means detects contemporaneously the plurality of different context parameters.

43. A portable electronic device as claimed in claim 35, wherein the plurality of different context parameters comprises at least one that is user dependent.

44. A portable electronic device as claimed in claim 35, wherein the plurality of different context parameters comprises a parameter that indicates the proximity of a portable electronic device that is previously known to the portable electronic device.

45. A method of providing a context dependent alert in a portable electronic device comprising:
defining a plurality of different trigger contexts by storing, for each context, the value(s) of one or more of a plurality of different context parameters; detecting a context by detecting the values of the plurality of different context parameters; and
controlling a user interface to produce an alert when a detected context corresponds to a stored trigger context.
